(19) United States
(12) Patent Application Publication
(10) Pub. No.: US 2010/0002449 A1
(43) Pub. Date: Jan. 7, 2010

(54) METHOD FOR FABRICATING MICRO-LENS AND MOLD CAVITY THEREOF AND LIGHT EMITTING DEVICE

(75) Inventor: Wai-Ping Lin, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: AUROTEK CORPORATION, LTD., Taipei City (TW)

(21) Appl. No.: 12/487,467

(22) Filed: Jun. 18, 2009

(30) Foreign Application Priority Data
Jul. 4, 2008 (TW) 097125165

(51) Int. Cl. F21V 5/04; B29D 11/00; C23F 1/02; B05D 3/10

(52) U.S. Cl. 362/311.01; 264/2.5; 216/58; 216/83; 427/133

(57) ABSTRACT

A method for fabricating a micro-lens and a mold cavity thereof and a light emitting device are provided. The method includes providing a substrate having a first surface for a plurality of micro nanometer structures to be disposed and arranged thereon. A metallic thin film layer is deposited on the first surface and micro nanometer structures of the substrate, and partially exposing the micro nanometer structures from the metallic thin film layer. Each of the micro nanometer structures is removed to form a mold cavity having a second surface so as to form a micro-lens having a micro nanometer lenticular face array, thereby enabling the light of light source passing through the micro nanometer structures to generate mass refraction. The micro nanometer structure of the present invention provides more even illumination and more extensive distribution, and the cost of material, power consumption, and manufacturing equipment involved are reduced.

### BACKGROUND OF THE INVENTION

1. Field of the Invention

This invention generally relates to method for fabricating a micro-lens and a mold cavity thereof and a light emitting device, and more specifically to a method for fabricating a micro-lens capable of enabling a light source to generate uniform light, and mold cavity thereof and a light emitting device.

2. Description of Related Art

A light emitting diode (LED) is a semiconductor optoelectronic element capable of emitting light, wherein the principle of light emission thereof is that in the combining process of electrons and so-called holes at the PN interface, energy is released in the form of photons sufficient for forming a light source. The light emitting element of an LED is encapsulated by a lens surface, wherein proper reflection of the lens will effectively radiate the light source and achieve a light illumination effect. An LED has many advantages, such as small size, light weight, high light emission efficiency, and so on. LEDs are widely adopted in illumination applications and as message indications. However, light emitted by the light emitting element of an LED through an integrated substrate is radiated in a scattered pattern, and thus such a light source does not radiate a concentrated beam. Therefore, the perceived brightness of LEDs does not achieve the desired effect in certain applications. Also, excessive heat is generated due to light scattering. Hence, it is a highly desirable issue in the industry to develop a way to enable such a light source to be more even and optimized, thereby enhancing light emission efficiency.

There are many designs and processing techniques for even and optimized light sources. Many of the techniques are applied in backlight modules, such as a diffusion filter for optical filters in a backlight module. For example, a plurality of single or multi-chip packaged light emitting element lenses can be used to provide light source distribution. Also, a secondary lens can be utilized to adjust the light source direction. However, such optimized designs are rarely done with the aim of increasing light emission quantity and evenness of the light source. In other words, light emission efficiency has a higher priority in most designs of light emitting elements, and light distribution is subsequently adjusted by design of light distribution device.

For example, a distributed Bragg reflector (DBR) structure comprising multiple alternating layers of high and low refractive index materials is disclosed in US Pat. No. 6,155,699, wherein the DBR structure performs as a reflecting layer for a light emitting diode for enhancing light emission efficiency of the light emitting diode.

Using a related principle, a dielectric stacking structure of high reflectivity is formed on a mesa wall of a reverse chip LED as disclosed by Taiwanese Patent No. 541,728, wherein the dielectric stacking structure is comprised of alternating layers of high and low refractive index layers, in which the high refractive index layers will reflect the majority of the guided light inside a light emitting diode chip radiating onto the coated mesa wall, so as to reduce the amount of light that would otherwise be consumed in the mesa wall. However, according to the above-mentioned patent, the high refractive dielectric stacking layers are formed only on the surface of the light emitting diode mesa wall. As such, light consumption still occurs on other sides.

According to the conventional light emitting structures utilized in light emitting diodes, no matter if such a structure is a DBR structure or an optically reflecting film structure, only part of light or the light of a particular wavelength can be reflected. Both designs need to include a secondary lens for adjusting the light source direction, so that such technologies involve complicated lithography processes or other manufacturing steps. Therefore, fabrication costs are rather high.

In addition, compared with the conventional design of a light source emission lens, the aforementioned design is restricted in terms of the geometry and structural size, as well as by difficulty in developing the related mold. Therefore, it is limited in effectively enhancing evenness and brightness of light emission. Moreover, since the fabrication method for the light emission lens of such a light emitting diode has higher cost, there are few products on the market employing the technique.

Hence, it is a highly critical issue in the industry to provide a method for fabricating a micro-lens and mold cavity thereof, wherein the method is capable of decreasing the consumption of material and power, reducing the required fabrication equipment, and generating mass refraction to provide more even illumination and more extensive light distribution, thereby effectively solving the drawbacks of the prior arts.

### SUMMARY OF THE INVENTION

In view of the disadvantages of the prior art mentioned above, the present invention provides a method for fabricating a micro-lens and a mold cavity thereof and light emitting device that are capable of generating mass refraction, thereby providing more even illumination and more extensive light distribution.

The present invention further provides a method for fabricating a micro-lens and a mold cavity thereof and light emitting device that consume less material and power and rely on less fabrication equipment.

The present invention further provides a method for fabricating a micro-lens and a mold cavity thereof and light emitting device that have a simple and fast fabrication process and provide a high time-cost benefit as well.

In accordance with the present invention the fabrication method of the micro-lens mold cavity comprises the steps of: providing a substrate having a first surface; disposing and arranging a plurality of micro nanometer structures on the first surface; depositing a metallic thin film layer on the first surface and the micro nanometer structures of the substrate, and also partially exposing each of the micro nanometer structures from the metallic thin film layer; and removing each of the micro nanometer structures to form a mold cavity comprising a second surface.

According to the fabrication method of the mold cavity of the present invention, the fabrication method of the micro-lens of the present invention comprises the steps of: mixing micro nanometer particles into a moldable micro-lens material, and pouring the micro-lens material mixed with the micro nanometer particles onto the second surface of the mold cavity; and removing the micro-lens material mixed with the micro nanometer particles after solidifying and being shaped, so as to form a micro-lens comprising a micro nanometer lenticular face array.

According to said fabrication method, each of the micro nanometer structures is disposed and arranged in a gas or liquid phase, and control parameters are selected from the group consisting of applied external electric field, magnetic field, pH of solution, and temperature.

According to the fabrication method, each of the micro nanometer structures is selected made of macromolecular materials or ceramic materials, such as silicon oxide, silicon dioxide, titanium oxide, titanium dioxide, polystyrene, PMMA, barium oxide, barium titanate, barium sulfate or aluminum oxide.

According to the fabrication method, the size of each of the micro nanometer structures is between 0.01 μm and 5 μm.

According to the fabrication method, the micro nanometer structures are not restricted to a regular matrix arrangement. In other words, they can be in a face-centered cubic arrangement, hexahedral stacked arrangement, alternately-spaced arrangement without gaps, or alternately-spaced arrangement with gaps, wherein the spacing distance between adjacent two micro nanometer structures is between 0.001 μm and 10 μm.

The micro-lens material and micro nanometer structure particles of fixed density are mixed evenly in a specified ratio.

The fabrication method further comprises the steps of fabricating a micro-lens of a multi-layered structure. The fabrication method of said micro-lens of a multi-layered structure comprises the steps of: providing a substrate having a first surface; disposing and arranging a plurality of micro nanometer structures on the first surface; depositing a metallic thin film layer on the first surface and the micro nanometer structures of the substrate, and also partially exposing each of the micro nanometer structures from the metallic thin film layer; removing each of the micro nanometer structures to form a first mold cavity comprising a second surface; mixing moldable micro-lens material with micro nanometer particles, and pouring the micro-lens material mixed with the micro nanometer particles onto the second surface of the first mold cavity; removing the micro-lens material mixed with the micro nanometer particles after solidifying and being shaped to form a micro-lens comprising a micro nanometer lenticular face array; fabricating a second mold cavity according to the steps of forming the first mold cavity, wherein the second mold cavity comprises a third surface comprising the lenticular face; pressing down the micro nanometer lenticular face array of the micro-lens toward a third surface of the second mold cavity, thereby forming a gap between the micro nanometer lenticular face array of the micro-lens and the third surface of the second mold cavity; pouring micro-lens material into the gap; and after the micro-lens material poured into the gap solidifies into the desired shape, removing the micro-lens from the second mold cavity. The micro-lens of a multi-layered structure is thus formed.

In the micro-lens of a multi-layered structure, each layered structure of the micro-lens is made of material selected from the group consisting of silica gel, acrylic, glass, epoxy resin, silicone, and others. The refraction indices of the materials of each layer structure of the micro-lens are in a regularly or irregularly decreasing or increasing sequence. Also, the thickness of the material of each layered structure of the micro-lens is between 0.01 μm and 10 μm.

The light emitting device of the present invention comprises a substrate; a light emitting element disposed on the substrate; and a micro-lens disposed to encapsulate the substrate for packaging the light emitting element, wherein the micro-lens comprises a light emission face comprising a micro nanometer lenticular face.

In another embodiment of the light emitting device of the present invention, the micro-lens is comprised of a plurality of stacked micro-lenses comprising a micro nanometer lenticular face.

In summary, the method of fabricating a micro-lens and mold cavity thereof and light emitting device in the present invention provides a substrate comprising a first surface for a plurality of micro nanometer structures of integrated single grains to be disposed and arranged thereon; next, a metallic thin film layer is deposited on the first surface of the substrate and micro nanometer structures, and then each of the micro nanometer structures is partially exposed from the metallic thin film layer; then, subsequently, each of the micro nanometer structures is removed to form a mold cavity comprising a second surface, and then the mold cavity is used for further forming micro-lenses comprising a micro nanometer lenticular face array, thereby enabling light of the light source to generate mass refraction through the micro nanometer structures, and thus providing more even illumination and more extensive distribution. By such a method, the present invention is also capable of reducing the use of material and power, as well as the degree of reliance on fabrication equipment, and is further capable of forming a multi-layered micro-lens for providing a more even illumination by using a micro-lens materials of various refraction indices, thereby enabling a plurality of light sources of high brightness to approach a more ideal single light source.

### BRIEF DESCRIPTION OF DRAWINGS

The present invention can be more fully understood by reading the following detailed description of the preferred embodiments, with reference made to the accompanying drawings, wherein:

FIG. 1 is a light emission diagram illustrating a light emitting device fabricated by using the method for fabricating a micro-lens according to the first embodiment of the present invention;

FIGS. 2A through 2D are cross-sectional diagrams illustrating the method for fabricating a micro-lens mold cavity according to the first embodiment of the present invention;

FIGS. 3A and 3B are Scanning Electron Microscope (SEM) diagrams illustrating the synthesized nanospheres of the present invention;

FIGS. 4A through 4D are cross-sectional diagrams illustrating the steps of fabricating a micro-lens by using the method for fabricating a micro-lens mold cavity according to the first embodiment of the present invention;

FIG. 5 is a light emission diagram illustrating a light emitting device fabricated by using the method for fabricating a micro-lens according to the first embodiment of the present invention;

FIGS. 6A through 6C are cross-sectional diagrams showing the method for fabricating a micro-lens according to the second embodiment of the present invention;

FIG. 7 is a diagram illustrating a micro nanometer structure dispensed on the substrate in a face-centered cubic arrangement without gaps according to the method for fabricating a micro-lens mold cavity in the present invention;

FIG. 8 is a diagram illustrating a micro nanometer structure dispensed on the substrate in a face-centered cubic arrangement with gaps according to the method for fabricating a micro-lens mold cavity in the present invention;

FIG. 9 is a diagram illustrating a micro nanometer structure dispensed on the substrate in a hexahedral stacked arrangement with gaps according to the method for fabricating a micro-lens mold cavity of the present invention; and

FIG. 10 is a diagram illustrating a micro nanometer structure dispensed on the substrate in a hexahedral stacked arrangement without gaps according to the method for fabricating a micro-lens mold cavity of the present invention.

### DETAILED DESCRIPTION OF PREFERRED EMBODIMENTS

The following illustrative embodiments are provided to illustrate the disclosure of the present invention. These and other advantages and effects can be readily understood by those skilled in the art after reading the disclosure of this specification. The present invention can also be performed or applied by other differing embodiments. The details of the specification may be presented on the basis of specific points and applications, and numerous modifications and variations can be devised without departing from the spirit of the present invention.

### First Embodiment

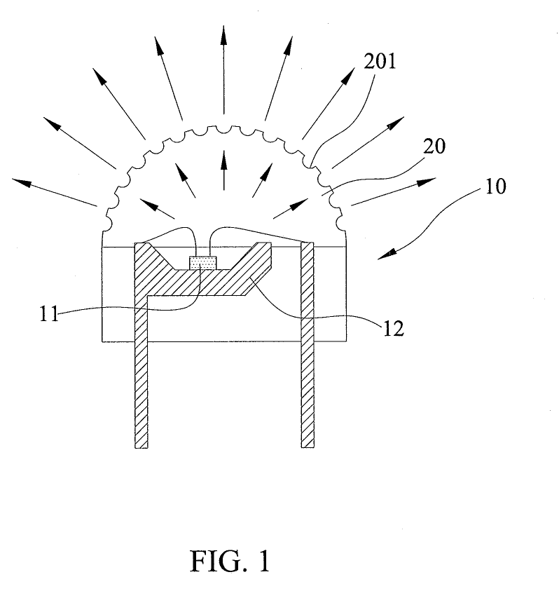

Please refer to FIG. 1, which is a light emission diagram illustrating a light emitting device fabricated by using the first embodiment method of the present invention for fabricating a micro-lens, the light emitting device being, for example, a light emitting diode. As shown in the figure, a light emitting device 10 includes a light emitting element 11 and a substrate 12, wherein the light emitting element 11 is disposed on the substrate 12 for providing a light source. Also, a micro-lens 20 is used to cover the substrate 12 for packaging the light emitting element 11. Since the light emission face of the micro-lens in the present invention is a micro nanometer lenticular face 201 comprising depressions or protrusions, the micro-lens is capable of evenly guiding out the light generated by the light emitting element 11.

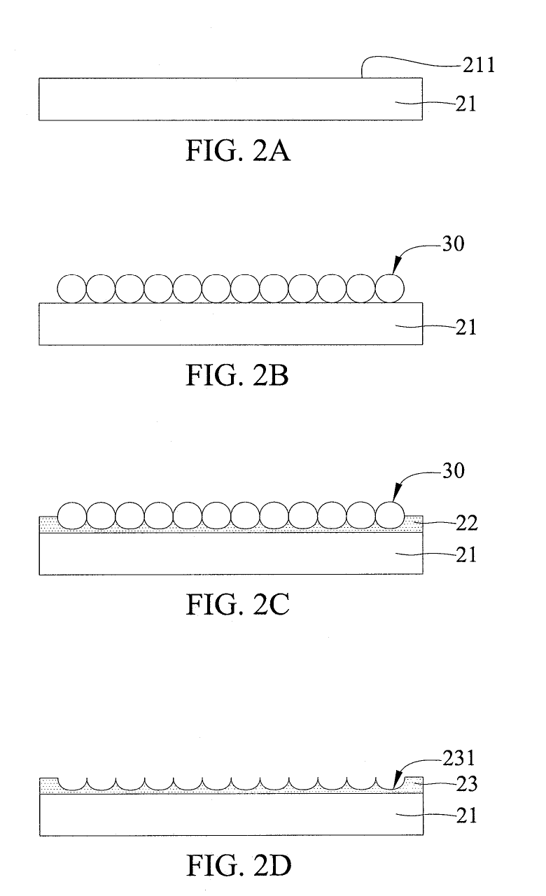

Please refer to FIGS. 2A through 2D, which are cross-sectional diagrams illustrating the first embodiment of the method of the present invention for fabricating a micro-lens mold cavity.

As shown in FIG. 2A, a substrate 21 has a first surface 211.

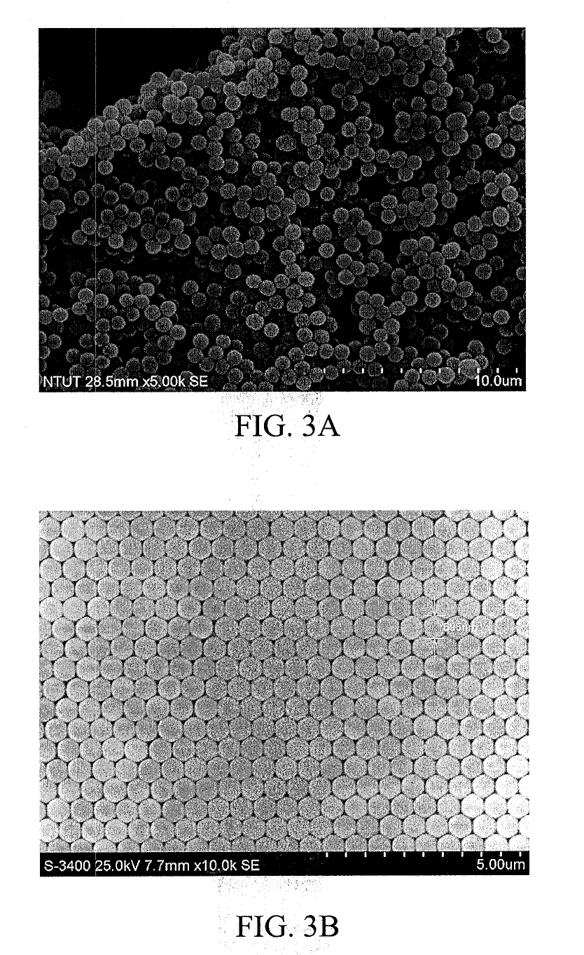

As show in FIG. 2B, a plurality of micro nanometer structures 30 are disposed and arranged on the first surface 211, wherein each of the micro nanometer structures can be made of one selected from the group consisting of macromolecule materials and ceramic materials, such as silicon oxide, silicon dioxide, titanium oxide, titanium dioxide, polystyrene, PMMA, barium oxide, barium titanate, barium sulfate or aluminum oxide. The size of each of the micro nanometer structures is between 0.01 μm and 1 μm. FIGS. 3A and 3B are SEM diagrams showing the nanospheres dispensed on the substrate surface. Each of the micro nanometer structures 30 can be arranged in a regular or irregular pattern on the first surface 211. In regards to the deposition manner, each of the micro nanometer structures 30 can be disposed and arranged in gas or liquid phase. For example, the disposition can be effected by suspending the substrate 21 in an electrolyte (not shown in the FIGs.) and then applying positive and negative voltages to the electrolyte and the substrate 21, respectively, thereby enabling the particles of the micro nanometer structures 30 to levitate due to the electric field resulting from the applied voltages and then be disposed and arranged on the first surface 211 of the substrate 21 by, for example, electrophoresis, wherein the parameters including the electric field, magnetic field, pH value of the solution, and process temperature should be carefully controlled for producing an optimized disposition arrangement.

As show in FIG. 2C, a metallic thin film layer 22 is deposited on the first surface 211 of the substrate 21 and the micro nanometer structures 30, wherein the micro nanometer structures 30 are partially exposed from the metallic thin film layer 22. The method of depositing the metallic thin film layer 22 can be, but not limited to, Physical or Chemical Vapor Deposition (PVD or CVD), and the thickness of the metallic thin film layer 22 is less than the thickness of the micro nanometer structures 30.

Subsequently, as shown in FIG. 2D, each of the micro nanometer structures 30 is removed, thus forming a mold cavity 23 comprising a second surface 231. Regarding the removal process, the macromolecular or ceramic micro nanometer structures can be removed from the surface by means of wet etching or dry etching, thus forming a mold cavity 23 comprising a large area of second surface 231 with either ordered or disordered micro nanometer structures thereon.

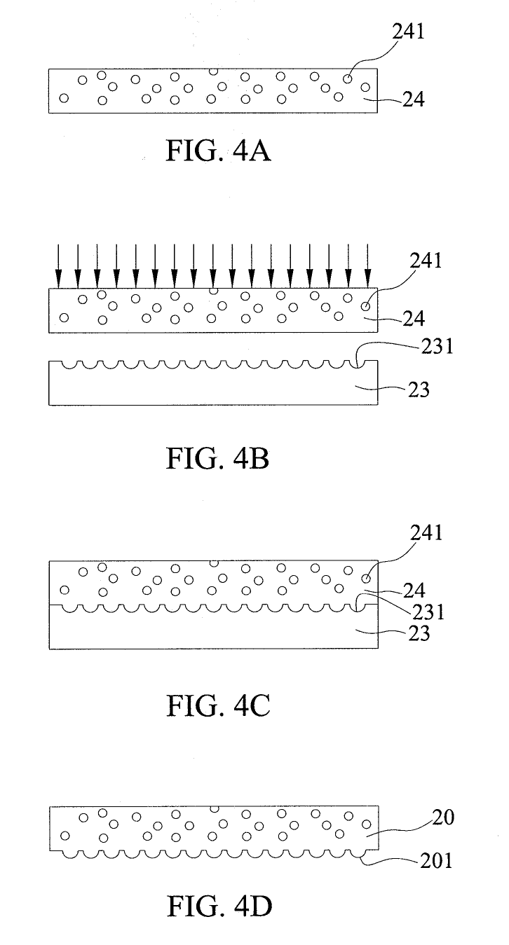

Please refer to FIGS. 4A through 4D, which are cross-sectional diagrams illustrating the steps of fabricating a micro-lens by using the first embodiment method of the present invention for fabricating a micro-lens mold cavity.

As shown in FIG. 4A, to achieve even light emission, micro nanometer structure particles 241 are mixed into moldable micro-lens material 24. In particular, the micro-lens material 24 and micro nanometer structure particles 241 of fixed density are mixed evenly in a specific ratio, thereby enabling the micro nanometer particles 241 to be evenly dispersed inside the micro-lens material 24. Generally, the mix amount of the micro nanometer particles 241 is between 10% and 35% by weight.

As shown in FIG. 4B, after softening the prepared micro-lens material 24 evenly mixed with the micro nanometer particles 241, the prepared micro-lens material 24 is poured into the second surface 231 of the mold cavity 23.

Subsequently, as shown in FIG. 4C, the micro-lens material poured into the second surface 231 of the mold cavity 23 is allowed to solidify and take the shape of the mold, such as by baking.

As shown in FIG. 4D, the solidified and shaped micro-lens material 231 is removed from the mold cavity 23 to form a micro-lens 20 comprising a micro nanometer lenticular face 201 array, thereby packaging the light emitting element with the micro-lens 20 (referring to FIG. 1) and enhancing the evenness of light emission of the light emitting element through the lenticular face 201.

### Second Embodiment

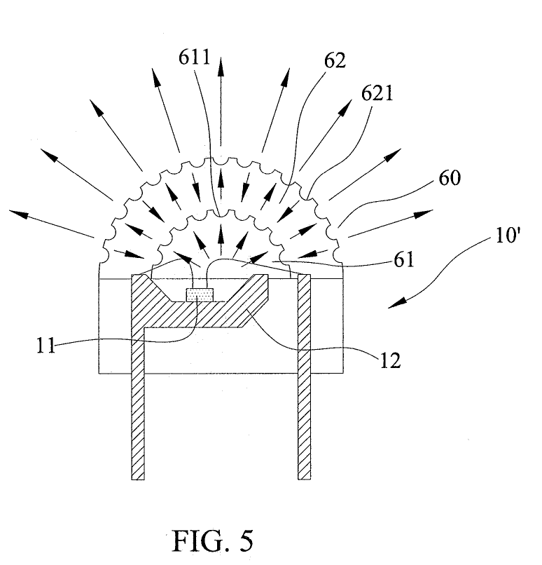

Please refer to FIG. 5, which is a light emission diagram illustrating a light emitting device fabricated by using the second embodiment of the present invention, wherein the light emitting device is a light emitting diode. As shown in the figure, the light emitting device 10′ includes a light emitting element 11 and a substrate 12, wherein the light emitting element 11 is disposed on the substrate 12 for providing a light source, and a micro-lens 60 is used to cover up the substrate 12 for packaging the light emitting element 11. The difference herein from the light emitting device 10 of FIG. 1 is that the micro-lens 60 of the second embodiment includes a plurality of stacked micro-lens layers 61 and 62 comprising micro nanometer lenticular faces 611 and 621, wherein the refraction indices of the micro-lens layers 61 and 62 are different from each other due to being made from different materials, and wherein a multi-layered film design is thus formed by means of alternating encapsulation. Accordingly, by using a plurality of layers of micro-lens material with various refraction indices, more optimized light evenness is obtainable, thereby enabling a plurality of high-brightness light sources to form a more ideal single light source.

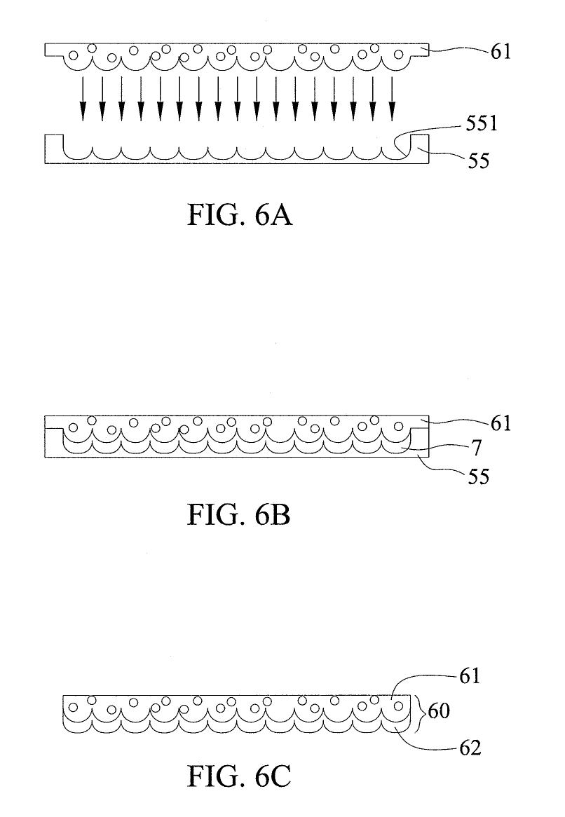

Please refer to FIGS. 6A through 6C, which are cross-sectional diagrams showing a method for fabricating a micro-lens according to the second embodiment of the present invention. The difference in the present embodiment from the method illustrated by FIGS. 4A through 4D is that the present embodiment is capable of fabricating a micro-lens 60 comprising a multi-layered structure.

A first mold cavity (not shown in the figures) is fabricated by the steps of the second embodiment of the present invention for fabricating a micro-lens mold cavity as illustrated by said FIGS. 2A through 2D, and also a first micro-lens layer 61 is fabricated by using the first mold cavity and the method of the present invention for fabricating a micro-lens as illustrated by FIGS. 4A through 4D. In addition, a second mold cavity 55 is fabricated by using the method for fabricating a micro-lens mold cavity in the present invention as illustrated by said FIGS. 2A through 2D. It should also be noted that the size of the second mold cavity 55 is larger than size of the first mold cavity.

As shown in FIG. 6A, the first micro-lens layer 61 is pressed into the second mold cavity 55.

Further, as shown in FIG. 6B, since the size of the second mold cavity 55 is larger than the size of the first mold cavity of the first micro-lens layer 61, after pressing the first micro-lens layer 61 into the second mold cavity 55, a gap 7 is thus formed between the first micro-lens layer 61 and the second mold cavity 55. Then, micro-lens material is poured into the gap 7 to form a second micro-lens layer 62.

As shown in FIG. 6C, after the micro-lens material poured into the gap 7 has solidified and shaped up, the micro-lens material is removed from the second mold cavity 55, thereby forming a multi-layered structure micro-lens 60 comprising the first micro-lens layer 61 and the second micro-lens layer 62. It should be noted herein, the un-solidified micro-lens material used in the present invention for forming the first micro-lens layer 61 and the second micro-lens layer 62 can be pre-mixed or not pre-mixed with micro nanometer particles, and also the micro-lens materials for forming the first micro-lens layer 61 and the second micro-lens layer 62 can be selected the group consisting of silica gel, acrylic, glass, epoxy resin and silicone. Furthermore, the refraction indices of the micro-lens materials forming the first micro-lens layer 61 and the second micro-lens layer 62 can be in a regularly or irregularly decreasing or increasing sequence. For example, the refraction indices can be in a regularly or irregularly decreasing or increasing sequence with respect to their differences or geometric ratio.

Similarly, a third micro-lens layer can be formed through the steps as illustrated by FIGS. 6A through 6C, and then a multi-layered structure micro-lens 60 comprising the first micro-lens layer 61 and the second micro-lens layer 62 can be further stacked with the third micro-lens layer (not shown in the figures herein). Therefore, by using micro-lenses of various refraction indices, light emission evenness can be more complete for enabling a plurality of light sources of high brightness to become an ideal single light source.

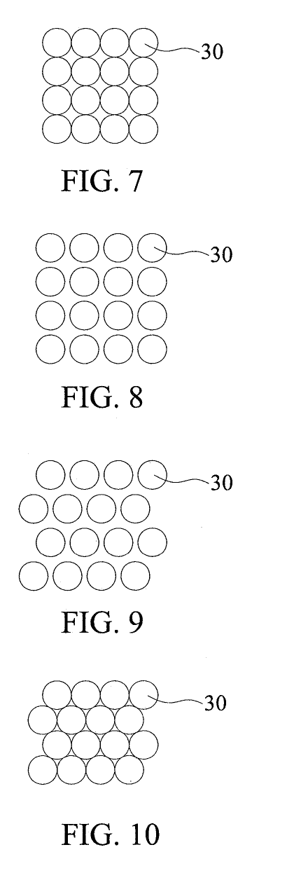

Furthermore, according to the method for fabricating a micro-lens mold cavity in the present invention, the distribution of the micro nanometer structures 30 on the substrate is not restricted to regular matrix arrangement, e.g. a face-centered cubic arrangement without gaps as shown in FIG. 7, or a face-centered cubic arrangement with gaps as shown in FIG. 8. In fact, the micro nanometer structures 30 can also be disposed and arranged in other modes, e.g. hexahedral stacking arrangement with gaps as shown in FIG. 9, or alternately spaced hexahedral stacking arrangement without gaps as shown in FIG. 10, wherein the spacing distance among the micro nanometer structures can be, but not limited, between 0.001 μm and 10 μm.

In summary, the method for fabricating a micro-lens and a mold cavity thereof in the present invention mainly provides a substrate comprising a first surface for disposing and arranging a plurality of micro nanometer structures thereon; a metallic thin film layer is deposited on the first surface and the micro nanometer structures of the substrate, and each of the micro nanometer structures is partially exposed from the metallic thin film layer; subsequently, each of the micro nanometer structures is removed to form a mold cavity comprising a second surface, and then a micro-lens comprising a micro nanometer lenticular face array is formed by using said mold cavity, wherein the method of the present invention is capable of reducing consumption of material and cost and using less equipment as well, and also producing a mass refraction for providing more even illumination and more extensive light distribution; and each of the micro-lenses is stacked to form a multi-layered micro-lens, and then by using micro-lenses of various refraction indices, light emission evenness can be more complete for enabling a plurality of light sources of high brightness to become an ideal single light source.

The foregoing descriptions of the detailed embodiments are only illustrated to disclose the features and functions of the present invention and are not restrictive of the scope of the present invention. It should be understood by those skilled in the art that various modifications and variations according to the spirit and principle in the disclosure of the present invention should fall within the scope of the appended claims.

What is claimed is:

1. A fabrication method for a micro-lens mold cavity, comprising the steps of:
providing a substrate having a first surface;
disposing and arranging a plurality of micro nanometer structures on the first surface;
depositing a metallic thin film layer on the first surface of the substrate and the micro nanometer structures, and partially exposing each of the micro nanometer structures from the metallic thin film layer; and
removing each of the micro nanometer structures to form a mold cavity comprising a second surface.

2. The fabrication method of claim 1, wherein each of the micro nanometer structures is disposed and arranged in a gas or liquid phase.

3. The fabrication method of claim 1, wherein control parameters during fabrication of each of the micro nanometer structures are selected from the group consisting of applied external electric fields, magnetic fields, pH solution, and temperature.

4. The fabrication method of claim 1, wherein each of the micro nanometer structures is made of macromolecular materials or ceramic materials.

5. The fabrication method of claim 1, wherein a size of each of the micro nanometer structures is ranged from 0.01 μm to 5 μm.

6. The fabrication method of claim 1, wherein a spacing distance between adjacent two micro nanometer structures of the micro nanometer structures is ranged from 0.001 μm to 10 μm.

7. The fabrication method of claim 1, wherein removing each of the micro nanometer structures is performed by means of wet etching or dry etching.

8. A fabrication method for a micro-lens, wherein the micro-lens is used for packaging a light-emitting element, comprising the steps of:
providing a substrate having a first surface;
disposing and arranging a plurality of micro nanometer structures on the first surface;
depositing a metallic thin film layer on the first surface of the substrate and the micro nanometer structures, and partially exposing each of the micro nanometer structures from the metallic thin film layer;
removing each of the micro nanometer structures to form a first mold cavity comprising a second surface;
mixing micro nanometer particles into moldable micro-lens material, and pouring the micro-lens material mixed with the micro nanometer particles onto the second surface of the first mold cavity; and
removing the micro-lens material mixed with the micro nanometer particles after solidifying and being shaped, allowing forming a micro-lens comprising a micro nanometer lenticular face array.

9. The fabrication method of claim 8, wherein each of the micro nanometer structures is disposed and arranged in a gas or liquid phase.

10. The fabrication method of claim 8, wherein control parameters utilized to fabricate each of the micro nanometer structures are selected from the group consisting of applied external electric fields, magnetic fields, pH solution, and temperature.

11. The fabrication method of claim 8, wherein each of the micro nanometer structures is made of macromolecule materials or ceramic materials comprising silicon oxide, silicon dioxide, titanium oxide, titanium dioxide, polystyrene, PMMA, barium oxide, barium titanate, barium sulfate and aluminum oxide.

12. The fabrication method of claim 8, wherein a size of each of the micro nanometer structures is ranged from 0.01 μm to 5 μm.

13. The fabrication method of claim 8, wherein each of the micro nanometer structures is disposed and arranged in a face-centered cubic arrangement.

14. The fabrication method of claim 8, wherein each of the micro nanometer structures is disposed and arranged in a hexahedral stacking arrangement or an alternately-spaced arrangement without gaps.

15. The fabrication method of claim 14, wherein a spacing distance between adjacent two micro nanometer structures of the micro nanometer structures is ranged from 0.001 μm to 10 μm.

16. The fabrication method of claim 8, wherein removing each of the micro nanometer structures is performed by means of wet etching or dry etching.

17. The fabrication method of claim 8, further comprising the steps of:
fabricating a second mold cavity according to the step of forming the first mold cavity, wherein the second mold cavity comprises a third surface with a lenticular face;
pressing the micro nanometer lenticular face array of the micro-lens toward the third surface of the second mold cavity, allowing forming a gap between the micro nanometer lenticular face array of the micro-lens and the third surface of the second mold cavity;
pouring material for forming a micro-lens into the gap; and
removing the micro-lens after the material poured into the gap solidifies and becomes shaped, and removing the micro-lens from the second mold cavity, allowing forming a micro-lens of multi-layered structure.

18. The fabrication method of claim 17, wherein each micro-lens layer is made of one selected from the group consisting of silica gel, acrylic, glass, epoxy resin and silicone.

19. The fabrication method of claim 17, wherein the refraction indices of the micro-lens layers are in a regularly or irregularly decreasing/increasing sequence.

20. The fabrication method of claim 17, wherein thickness of material of each micro-lens layer is between 0.01 μm and 10 μm.

21. The fabrication method of claim 17, wherein the micro-lens material and micro nanometer structure particles of fixed density are mixed evenly in a specific ratio.

22. The fabrication method of claim 8, wherein the micro-lens material stacked by two or more materials of different refractions and micro nanometer structure particles of fixed density are mixed evenly in a specific ratio, wherein each micro-lens has a regular/irregular micro nanometer structure in different micro-lens material.

23. A light emitting device, comprising:
a substrate;
a light emitting element disposed on the substrate; and
a micro-lens covering up the substrate for packaging the light emitting element, wherein the micro-lens comprises a light emission face including a micro nanometer lenticular surface.

24. The light emitting device of claim 23, wherein the micro-lens comprises a plurality of stacked micro-lenses having micro nanometer lenticular faces.
